(19) United States
(12) Patent Application Publication
(10) Pub. No.: US 2013/0332142 A1
(43) Pub. Date: Dec. 12, 2013

(54) METHODS AND APPARTUS FOR PERFORMING POWER ESTIMATION IN CIRCUITS

(71) Applicants: Leonid Lerner, Etz Efraim (IL); Dmitry Podvalny, Petah Tikva (IL); Alexander Shinkar, Rishon Lezion (IL)

(72) Inventors: Leonid Lerner, Etz Efraim (IL); Dmitry Podvalny, Petah Tikva (IL); Alexander Shinkar, Rishon Lezion (IL)

(73) Assignee: LSI CORPORATION, Milpitas, CA (US)

(21) Appl. No.: 13/493,713

(22) Filed: Jun. 11, 2012

(51) Int. Cl. G06F 9/45

(52) U.S. Cl. 703/22

(57) ABSTRACT

Power consumption is estimated for an application being executed by a circuit. Power consumption values are estimated for a set of base events executed by the circuit. The application is then reduced to an equivalent sequence of base events selected from the set of base events. Lastly, the estimated power consumption values for the base events in the equivalent sequence of base events are summed.

### BACKGROUND

Power consumption is an important performance metric in the development of circuitry. Power consumption can be estimated in the design phase of a circuit with synthesis and simulation techniques that utilize, for example, the Verilog hardware description language (HDL) or the very high speed integrated circuit (VHSIC) hardware description language (VHDL). Nevertheless, such estimation is typically a complicated, time-consuming, and multistep process. To estimate the power consumption of a given application running on a particular circuit, high-level register-transfer level (RTL) code is typically first developed to describe the circuit. Subsequently, the RTL code is synthesized by a synthesis tool to produce a gate-level description. Finally, the power consumption for that particular application is estimated by simulating the running of the application on the circuit with a simulation tool that utilizes the gate-level description. In this manner, each application must ultimately be simulated to estimate its power consumption characteristics.

### SUMMARY

Embodiments of the invention provide novel methods and apparatus for performing power estimation for an application executed by a circuit. The power consumption is first estimated for a set of base events that can be executed by the circuit. These base events may include reading from a memory, writing to a memory, reading from a register, writing to a register, adding, multiplying, and so on. The application is then reduced to an equivalent sequence of base events selected from the set of base events. Once these steps have been performed, power estimation for the application can be estimated by summing the estimated power consumption for each base event in the equivalent sequence of base events for the application. In so doing, the application itself need not be separately simulated in order to estimate its power consumption. Substantial savings are thereby afforded in both time and other resources.

In accordance with an aspect of the invention, power consumption is estimated for an application being executed by a circuit. Power consumption values are estimated for a set of base events executed by the circuit. The application is then reduced to an equivalent sequence of base events selected from the set of base events. Lastly, the estimated power consumption values for the base events in the equivalent sequence of base events are summed.

In accordance with another aspect of the invention, an apparatus comprises a memory and at least one processor coupled to the memory. The at least one processor is operative to estimate power consumption values for a set of base events executed by the circuit. In addition, the at least one processor is operative to reduce the application to an equivalent sequence of base events selected from the set of base events. Finally, the at least one processor is operative to sum the estimated power consumption values for each of the base events in the equivalent sequence of base events.

Embodiments of the present invention will become apparent from the following description of embodiments thereof, which are to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 shows a data flow diagram of a method for performing event-based power estimations in accordance with an illustrative embodiment of the invention;

FIG. 2 shows an exemplary table that associates base events with respective estimated power consumption values;

FIG. 3 shows a data flow diagram of a method for performing application-based power estimations in accordance with an illustrative embodiment of the invention;

FIG. 4 shows an exemplary table that associates application instructions with respective base events;

FIG. 5 shows an exemplary table that associates the sequence of base events for an application with respective estimated power consumption values; and

FIG. 6 shows a block diagram of at least a portion of a data processing system for performing aspects of the invention in accordance with an illustrative embodiment of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

The present invention, according to aspects thereof, will be described herein in the context of illustrative methods and data processing systems for estimating power consumption in circuits. It will become apparent to those skilled in the art given the teachings herein that numerous modifications can be made to the embodiments shown that are within the scope of the present invention. That is, no limitations with respect to the specific embodiments described herein are intended or should be inferred.

As a preliminary matter, for the purposes of clarifying and describing embodiments of the invention, the following table provides a summary of certain acronyms and their corresponding definitions, as the terms are used herein:

Table of Acronym Definitions

| Acronym | Definition |
|---|---|
| HDL | hardware description language |
| VHDL | VHSIC hardware description language |
| VHSIC | very high speed integrated circuit |
| RTL | register-transfer level |
| GLD | gate-level description |
| SDF | standard delay format |
| FPGA | field-programmable gate array |
| ASIC | application-specific integrated circuit |
| DB | database |
| I/O | input/output |
| NVRAM | nonvolatile random access memory |
| DRAM | dynamic random access memory |
| ROM | read-only memory |
| OS | operating system |
| EEPROM | electrically erasable programmable ROM |

A method in accordance with an illustrative embodiment of the invention for estimating the power consumption of an application being executed by a circuit may be conceptually separated into two phases: 1) an event-based power estimation phase, and 2) an application-based power estimation phase. As used herein, the term “application” is intended to be construed broadly and may comprise any sequence of instructions that can be executed by a processor, for example, a processor in a circuit under test.

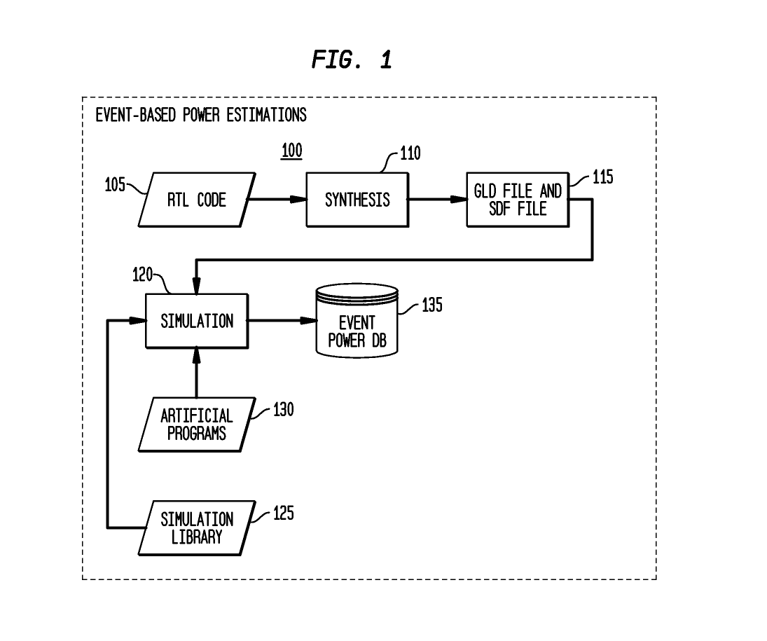

FIG. 1 starts by showing a data flow diagram of an exemplary method 100 for event-based power calculations. As is customary in the circuit design arts, the description of the circuit under test in the present embodiment begins in the form of RTL code, as indicated by block 105. The RTL code may, for example, describe the circuit under test in terms of the flow of digital signals between hardware registers, and the logical operations performed on those signals. The RTL code, in turn, is synthesized in block 110 to form a gate-level description (GLD) file as well as a standard delay format (SDF) file, as indicated in block 115. The synthesis process may, for example, compile and map the RTL code into a gate-level description of a field-programmable gate array (FPGA) or an application-specific integrated circuit (ASIC), as desired. The GLD file describes the circuit under test in terms of a network of gates and registers, while the SDF file describes technology-specific delay information for each gate.

Verilog and VHDL are very common hardware description languages for register-transfer and gate-level abstractions of circuits. Moreover, synthesis tools are available from a number of vendors including, for example, Synopsys®, Inc. (Mountain View, Calif., USA) and Cadence Design Systems, Inc. (San Jose, Calif., USA). These aspects of the circuit and others are described in a number of readily available references including, for example, S. Ramachandran, Digital VLSI Systems Design: A Design Manual for Implementation of Projects on FPGAs and ASICs Using Verilog, Springer, 2007; and V. Pedroni, Digital Electronics and Design with VHDL, Morgan Kaufmann, 2008, both of which are hereby incorporated by reference herein.

Subsequently, a gate-level power simulation (i.e., analysis) of the circuit under test is performed in block 120 of FIG. 1. This power simulation utilizes the GLD and SDF files from the synthesis in block 115 in combination with a simulation library in block 125. The simulation library provides information on the cells forming the gate-level description including their power consumption values. However, rather than simulating the execution of an application on the circuit under test, as is conventional during circuit design, a series of discrete base events are instead simulated. Such a simulation occurs through the execution of one or more artificial programs from block 130. The set of base events defined by the artificial programs preferably include all the events (i.e., operations) that can be performed by the circuit under test. Such base events may include, for example, reading from a memory, writing to a memory, reading from a register, writing to a register, adding, multiplying, and so on.

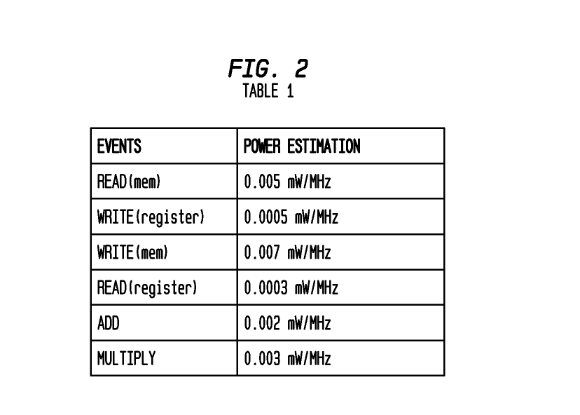

Tools for gate-level power simulations such as that performed in block 120 are also available from a number of commercial vendors. One popular choice is, for example, Primetime PX from Synopsys®, Inc., although there are several others. The results of the simulation in block 120 are stored in the event power database (DB) in block 135. The associations may, for example, be stored in the form of a table such as Table 1 shown in FIG. 2. Table 1 acts to associate each of a set of exemplary base events with their respective estimated power consumption values as determined by the simulation in block 120. Power consumption values in this embodiment are expressed in milliwatts per megahertz (mW/MHz), although other representations of estimated power consumption values are similarly contemplated.

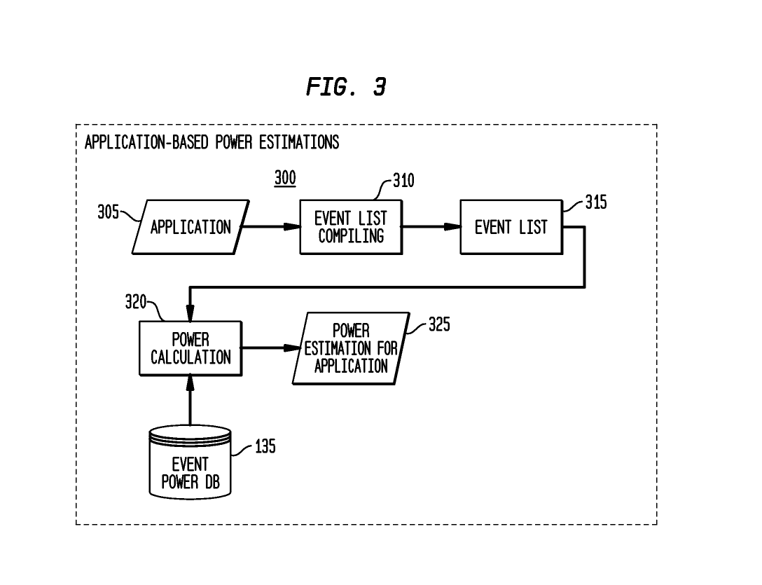

Once so determined, the power consumption data stored in the event power database (block 135 in FIG. 1) may be utilized to perform the second phase of the method for estimating the power consumption of an application being executed by a circuit, namely, the application-based power estimation phase. FIG. 3 shows a data flow diagram of an exemplary method 300 for application-based power estimations.

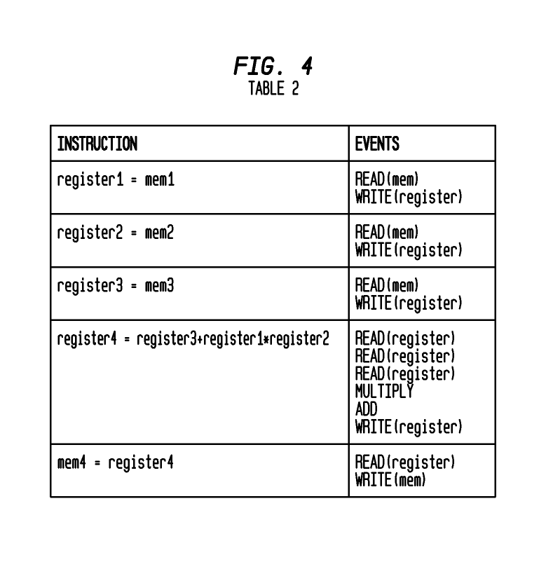

The method 300 starts by taking an application (block 305) for which total power consumption is to be determined and reducing the application down to an equivalent sequence of base events selected from the set of base events stored in Table 1 (FIG. 2). Such a task is performed by an event list compiling process in block 310. The event list compiling process may, for example, utilize a look-up table that relates each of the program instructions in the application with a respective equivalent series of one or more base events selected from the set of base events. The end result of such compiling of the application is the event list indicated by block 315. An illustrative event list for a simple exemplary application is shown in Table 2 in FIG. 4. Table 2 associates exemplary higher-level program instructions with their respective equivalent base events. As indicated in the first row, for example, an instruction commanding that the value stored in a “mem1” be stored in a “register1” can be reduced to two base events: 1) reading from a memory (Read(mem)); and 2) writing to a register (Write(register)). As indicated in the fourth row, the instruction:

register4=register3+register1*register2

can be reduced to six base events: 1) reading from a register (Read(register)); 2) reading from a register (Read(register)); 3) reading from a register (Read(register)); 4) performing a multiplication (Multiply); 5) performing an addition (Add); and 6) writing to a register (Write(register)).

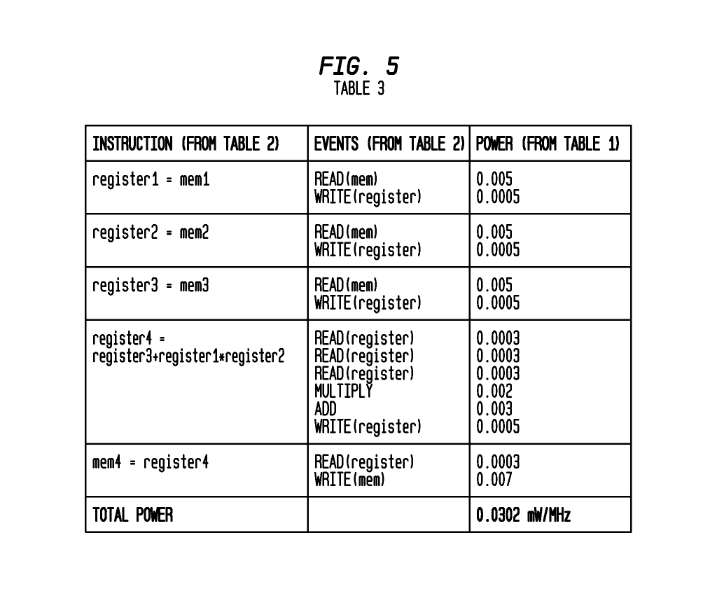

With the application reduced from a sequence of higher-level program instructions to an equivalent sequence of base events for which power consumption values were estimated in phase one of the method, the estimation of the power consumption for execution of the application on the circuit under test becomes as simple as summing the estimated power consumption values for the base events in the equivalent sequence of base events. The power consumption values can be obtained from the event power database, also shown in FIG. 3 as block 135. Table 3 in FIG. 5 associates the equivalent sequence of base events for the exemplary application from Table 2 (FIG. 4) with their respective illustrative estimated power consumption values. As indicated in Table 3, summing these values allows the total power estimation for that application to be estimated at 0.0302 mW/MHz.

Notably, by performing the power estimation by summing an equivalent sequence of base events in the above-described manner, there is no longer a need to run a gate-level simulation for each application. Rather, once the event power database is populated by running the simulation for the one or more artificial programs, power estimations for any number of applications can be made without further simulations. Significant savings in time and other resources are thereby gained by implementing aspects of the invention when compared to conventional power estimation techniques.

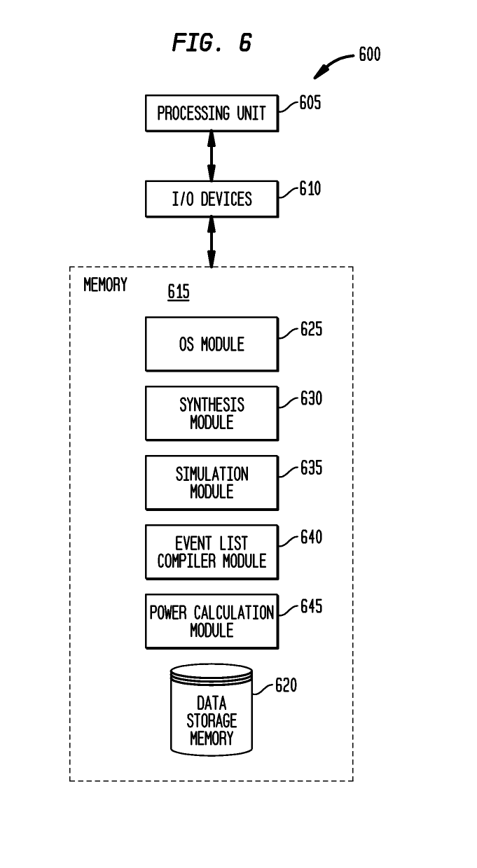

FIG. 6 shows a block diagram of at least a portion of an exemplary data processing system 600 operative to perform the just-described two-phase methodology for estimating the power consumption of an application being executed by a circuit under test. In this particular embodiment, the data processing system 600 comprises a processing unit 605, input/output (I/O) devices 610, and a memory 615. The memory 615, in turn, comprises computer instructions (applications) that may be executed by the processing unit 605, as well as data storage memory 620. The I/O devices 610 comprise that hardware necessary to allow the data processing system 600 to communicate with the outside world (e.g., network adapters, keyboards, pointing devices, printers, monitors, etc.). The memory 615 comprises one or more caches, disks, hard drives, non-volatile random access memories (NVRAMs), dynamic random access memories (DRAMs), read-only memories (ROMs), and/or Flash ROMs.

For purposes of describing the present embodiment of the invention, the computer instructions (i.e., application software or firmware) stored in the memory 615 may be conceptually separated into an operating system (OS) module 625, a synthesis module 630, a simulation module 635, an event list compiler module 640, and a power calculation module 645. The OS module 625, when executed by the processing unit 605, allows the data processing system 600 to manage computer hardware resources and to provide common services for the other application software and firmware. The synthesis module 630, in turn, when executed by the processing unit 605, allows the data processing system 600 to perform the synthesis process in block 110 of FIG. 1. The simulation module 635, when executed by the processing unit 605, allows the data processing system 600 to perform the simulation process in block 120 of FIG. 1. The event list compiler module 640, when executed by the processing unit 605, allows the data processing system 600 to perform the event list compiling process indicated as block 310 in FIG. 3. Lastly, the power calculation module 645, when executed by the processing unit 605, allows the data processing system 600 to perform the power calculation process shown as block 320 in FIG. 3.

As is known in the art, at least a portion of one or more aspects of the methods and apparatus discussed herein may be distributed as an article of manufacture that itself includes a computer readable medium having non-transient computer readable code means embodied thereon. The computer readable program code means is operable, in conjunction with a computer system, to carry out all or some of the steps to perform the methods or create the apparatus discussed herein. The computer readable medium may be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store, in a non-transitory manner, information suitable for use with a computer system may be used. The computer-readable program code means is intended to encompass any mechanism for allowing a computer to read instructions and data, such as magnetic variations on a magnetic medium or height variations on the surface of a compact disk. As used herein, a tangible computer-readable recordable storage medium is intended to encompass a recordable medium, examples of which are set forth above, but is not intended to encompass a transmission medium or disembodied signal.

At least a portion of the techniques of the present invention may be implemented in an integrated circuit. In forming integrated circuits, identical die are typically fabricated in a repeated pattern on a surface of a semiconductor wafer. Each die includes an element described herein, and may include other structures and/or circuits. The individual die are cut or diced from the wafer, then packaged as an integrated circuit. One skilled in the art would know how to dice wafers and package die to produce integrated circuits. Any of the exemplary elements illustrated in, for example, FIGS. 1, 3, and 6, or portions thereof, may be part of an integrated circuit. Integrated circuits so manufactured are considered part of this invention.

Moreover, it should again be emphasized that the above-described embodiments of the invention are intended to be illustrative only. Other embodiments may use different types and arrangements of elements for implementing the described functionality. These numerous alternative embodiments within the scope of the appended claims will be apparent to one skilled in the art given the teachings herein.

Lastly, the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

What is claimed is:

1. A method for estimating power consumption of an application being executed by a circuit, the method comprising the steps of:
estimating power consumption values for a set of base events executed by the circuit;
reducing the application to an equivalent sequence of base events selected from the set of base events; and
summing the estimated power consumption values for the base events in the equivalent sequence of base events.

2. The method of claim 1, wherein the estimating step further comprises storing the estimated power values.

3. The method of claim 1, wherein the application comprises a plurality of program instructions that can be executed by the circuit.

4. The method of claim 3, wherein the reducing step utilizes a look-up table that relates each of the plurality of program instructions with a respective equivalent series of one or more base events selected from the set of base events.

5. The method of claim 1, wherein the estimating step utilizes a gate-level description of at least a portion of the circuit.

6. The method of claim 5, wherein the gate-level description is generated at least in part from a register-transfer language description of at least a portion of the circuit.

7. The method of claim 1, wherein the set of base events comprises a base event that represents reading content from a memory.

8. The method of claim 1, wherein the set of base events comprises a base event that represents writing content to a memory.

9. The method of claim 1, wherein the set of base events comprises a base event that represents reading content from a register.

10. The method of claim 1, wherein the set of base events comprises a base event that represents writing content to a register.

11. The method of claim 1, wherein the set of base events comprises a base event that represents adding numbers.

12. The method of claim 1, wherein the set of base events comprises a base event that represents multiplying numbers.

13. The method of claim 1, further comprising providing a system, wherein the system comprises a plurality of distinct software modules, each of the plurality of distinct software modules being embodied on a computer-readable storage medium, and wherein the plurality of distinct software modules comprises a simulation module, a compiler module, and a power calculation module, wherein:
the estimating step is carried out by the simulation module executing on at least one hardware processor;
the reducing step is carried out by the compiler module executing on the at least one hardware processor; and
the summing step is carried out by the power calculation module executing on the at least one hardware processor.

14. The method of claim 13, wherein the computer-readable storage medium is a non-transitory computer-readable storage medium.

15. The method of claim 1, further comprising the step of refining the circuit based at least in part on the results of the summing step.

16. The method of claim 1, further comprising the step of forming at least a portion of the circuit into an integrated circuit.

17. An apparatus for estimating power consumption of an application being executed by a circuit, the apparatus comprising:
a memory; and
at least one processor coupled to the memory, the at least one processor operative to:
estimate power consumption values for a set of base events executed by the circuit;
reduce the application to an equivalent sequence of base events selected from the set of base events; and
sum the estimated power consumption values for the base events in the equivalent sequence of base events.

18. The apparatus of claim 17, further comprising a plurality of distinct software modules, each of the plurality of distinct software modules being embodied on a computer-readable storage medium, and wherein the plurality of distinct software modules comprise a simulation module, a compiler module, and a power calculation module, wherein:
the at least one processor is operative to perform the estimating step by executing the simulation module;
the at least one processor is operative to perform the reducing step by executing the compiler module; and
the at least one processor is operative to perform the estimating step by executing the power calculation module.

19. An apparatus for estimating power consumption of an application being executed by a circuit, the apparatus comprising:
means for estimating power consumption values for a set of base events executed by the circuit;
means for reducing the application to an equivalent sequence of base events selected from the set of base events; and
means for summing the estimated power consumption values for the base events in the equivalent sequence of base events.
